(19) United States
(12) Patent Application Publication
(10) Pub. No.: US 2011/0106619 A1
(43) Pub. Date: May 5, 2011

(54) RECRUITMENT METHOD

(75) Inventor: Anastasia Moulis Zurnamer, Rose Bay (AU)

(73) Assignee: SMS ME JOBS PTY LTD, Rose Bay NSW (AU)

(21) Appl. No.: 12/933,560

(22) PCT Filed: Mar. 19, 2008
(86) PCT No.: PCT/AU08/00397

§ 371 Date: Dec. 13, 2010

(51) Int. Cl. G06Q 30/00

(52) U.S. Cl. 705/14.49

(57) ABSTRACT

A computer-implemented recruitment method is disclosed. Information about an individual is stored in a computer readable memory (e.g., 110) together with one or more job search criteria provided by the individual. One or more advertisements for one or more jobs are stored in a computer readable medium (e.g., 110) together with classification information associated with each of the advertisements. The advertisements are provided by one or more advertisers. The job search criteria is matched with the classification information associated with at least one of the advertisements, upon the at least one advertisement being activated. A message describing the job associated with the at least one advertisement is sent to a communications device nominated by the individual. Upon receiving a reply to the message from the individual, the stored information about the individual is sent electronically to the advertiser associated with the at least one job.

### FIELD OF THE INVENTION

The present invention relates generally to recruitment and, in particular, to a recruitment method, apparatus and system. The present invention also relates to a computer program product including a computer readable medium having recorded thereon a computer program for use in recruitment.

### BACKGROUND

Job seekers spend a lot of time and effort in looking for a new job, project or assignment. Similarly, employers spend a lot of time and effort in searcher for and recruiting new staff, including temporary workers and contractors.

A whole industry, generally referred to as the “recruitment” industry, has been created by the needs of both job seekers and employers. Recruiters (or head-hunters), employment/career consultants, employment agencies and the like, may be enlisted to act as intermediaries between job seekers and employers, by performing one or more steps in the recruitment process. The recruitment process typically includes advertising jobs, screening job seekers and employers to determine if the parties are suited and, in this instance, introducing the job seekers and employers.

However, the enlistment of intermediaries can be costly to both employers and job seekers, in terms of both time and money. Further, time and money can be wasted on such intermediaries when the pre-screening is not properly performed or if the requirements of the parties are not communicated between the parties.

As a result of the inefficiencies of intermediaries, websites advertising jobs have become popular in recent times. A job advertisement website typically works by an advertiser posting an advertisement for a job on the website. Job seekers searching for a job then log onto the website and view the advertisements posted on the website by that advertiser and other advertisers. If the job seeker finds the advertisement posted by the advertiser and thinks that they are suitable, then the job seeker typically emails or posts their resume and supporting documentation to the advertiser.

However, a disadvantage of job advertisement websites for the advertisers is that it often takes some time between the posting of an advertisement and job seekers replying to the advertisement. Further, the advertiser is often uncertain as to whether job seekers using the website will view their advertisement.

Similarly, a disadvantage of job advertisement websites for job seekers is that they never know when advertisements have been posted. By the time that the job seeker finds out about the job advertisement, it is often too late to apply for the job or someone else has been given the job.

Another disadvantage of job advertisement websites for job seekers is that the job seeker is required to periodically log-on to a website, enter their search terms and browse the website for any new advertisements placed on the Website. The job seeker must follow this procedure until they find a job.

Thus, a need clearly exists for an improved and more efficient recruitment method.

### SUMMARY

It is an object of the present invention to substantially overcome, or at least ameliorate, one or more disadvantages of existing arrangements.

According to one aspect of the present invention there is provided a computer-implemented recruitment method, said method comprising the steps of:

storing information about an individual in a computer readable memory together with one or more job search criteria provided by the individual;

storing one or more advertisements for one or more jobs, in a computer readable medium together with classification information associated with each of the advertisements, the advertisements being provided by one or more advertisers;

matching the job search criteria with the classification information associated with at least one of the advertisements, upon the at least one advertisement being activated;

sending a message describing the job associated with the at least one advertisement to a communications device nominated by the individual; and

receiving a reply to the message from the individual, wherein upon receiving the reply, the stored information about the individual is sent electronically to the advertiser associated with the at least one job.

According to another aspect of the present invention there is provided an apparatus for use in recruitment, said apparatus comprising:

a computer readable memory device for storing information about an individual in a computer readable memory together with one or more job search criteria provided by the individual, and for storing one or more advertisements for one or more jobs, in a computer readable medium together with classification information associated with each of the advertisements, the advertisements being provided by one or more advertisers;

a processor for matching the job search criteria with the classification information associated with at least one of the advertisements, upon the at least one advertisement being activated;

a transmitter for sending a message describing the job associated with the at least one advertisement to a communications device nominated by the individual; and

a receiver for receiving a reply to the message from the individual, wherein upon receiving the reply, the stored information about the individual is sent electronically to the advertiser associated with the at least one job.

According to still another aspect of the present invention there is provided a computer program product including a computer readable medium having recorded thereon a computer program for implementing a recruitment method, said program comprising:

code for storing information about an individual in a computer readable memory together with one or more job search criteria provided by the individual;

code for storing one or more advertisements for one or more jobs, in a computer readable medium together with classification information associated with each of the advertisements, the advertisements being provided by one or more advertisers;

code for matching the job search criteria with the classification information associated with at least one of the advertisements, upon the at least one advertisement being activated;

code for sending a message describing the job associated with the at least one advertisement to a communications device nominated by the individual; and

code for receiving a reply to the message from the individual, wherein upon receiving the reply, the stored information about the individual is sent electronically to the advertiser associated with the at least one job.

According to still another aspect of the present invention there is provided a computer-implemented recruitment method, said method comprising the steps of:

storing information about one or more individuals in a computer readable memory together with one or more job search criteria provided by the individuals;

activating an advertisement for a job, the advertisement comprising classification information associated with the job;

comparing the job search criteria provided by the individuals with the classification information, upon the advertisement being activated;

matching the classification information to the job search criteria provided by at least one of the individuals based on the comparison;

sending a message describing the job to a communications device nominated by the at least one individual; and

sending the stored information about the individual, via a communications network, to an advertiser associated with the job, upon receiving a reply to the message.

According to still another aspect of the present invention there is provided an apparatus for use in recruitment, said apparatus comprising:

a computer readable medium for storing information about one or more individuals together with one or more job search criteria provided by the individuals; and

a processor for activating an advertisement for a job, the advertisement comprising classification information associated with the job, the processor being configured for comparing the job search criteria provided by the individuals with the classification information, upon the advertisement being activated, and for matching the classification information to the job search criteria provided by at least one of the individuals based on the comparison, the processor being further configured for sending a message describing the job to a communications device nominated by the at least one individual, and sending the stored information about the individual, via a communications network, to an advertiser associated with the job, upon receiving a reply to the message.

According to still another aspect of the present invention there is provided a computer program product including a computer readable medium having recorded thereon a computer program for implementing a recruitment method, said program comprising:

storing information about one or more individuals in a computer readable memory together with one or more job search criteria provided by the individuals;

activating an advertisement for a job, the advertisement comprising classification information associated with the job;

comparing the job search criteria provided by the individuals with the classification information, upon the advertisement being activated;

matching the classification information to the job search criteria provided by at least one of the individuals based on the comparison;

sending a message describing the job to a communications device nominated by the at least one individual; and

sending the stored information about the individual, via a communications network, to an advertiser associated with the job, upon receiving a reply to the message.

According to still another aspect of the present invention there is provided a computer-implemented recruitment method, said method comprising the steps of:

storing information about one or more individuals in a computer readable memory together with one or more job search criteria provided by the individuals;

comparing the job search criteria provided by the individuals with classification information associated with an advertisement for a job, each time an advertisement is placed by an advertiser;

sending a message describing a job associated with at least one of the advertisements to a communications device nominated by at least one of the individuals, upon the classification information associated with the at least one advertisement matching the job search criteria associated with the individual; and

sending the stored information about the individual, via a communications network, to an advertiser associated with the advertisement, upon receiving a reply to the message.

According to still another aspect of the present invention there is provided an apparatus for use in recruitment, said apparatus comprising:

a computer readable medium for storing information about one or more individuals together with one or more job search criteria provided by the individuals;

a processor for comparing the job search criteria provided by the individuals with classification information associated with an advertisement for a job, each time an advertisement is placed by an advertiser, and for sending a message describing a job associated with at least one of the advertisements to a communications device nominated by at least one of the individuals, upon the classification information associated with the at least one advertisement matching the job search criteria associated with the individual, wherein the processor is further configured for sending the stored information about the individual, via a communications network, to an advertiser associated with the advertisement, upon receiving a reply to the message.

According to still another aspect of the present invention there is provided a computer program product including a computer readable medium having recorded thereon a computer program for implementing a recruitment method, said program comprising:

code for storing information about one or more individuals in a computer readable memory together with one or more job search criteria provided by the individuals;

code for comparing the job search criteria provided by the individuals with classification information associated with an advertisement for a job, each time an advertisement is placed by an advertiser;

code for sending a message describing a job associated with at least one of the advertisements to a communications device nominated by at least one of the individuals, upon the classification information associated with the at least one advertisement matching the job search criteria associated with the individual; and

code for sending the stored information about the individual, via a communications network, to an advertiser associated with the advertisement, upon receiving a reply to the message.

Other aspects of the invention are also disclosed.

### BRIEF DESCRIPTION OF THE DRAWINGS

Some aspects of the prior art and one or more embodiments of the present invention will now be described with reference to the drawings and appendices, in which:

FIG. 1 is a schematic block diagram of a computer, connected to a communications network, for use by an administrator of a Website in accordance with the preferred embodiment;

FIG. 2 is a schematic block diagram of a personal computer, connected to the communications network of FIG. 2, for use by an advertiser or a job seeker;

FIG. 3 is a flow diagram showing a recruitment method; and

FIG. 4 is a flow diagram showing a method of searching for job information.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of documents or devices which form public knowledge through their respective publication and/or use. Such should not be interpreted as a representation by the present inventor(s) or patent applicant that such documents or devices in any way form part of the common general knowledge in the art.

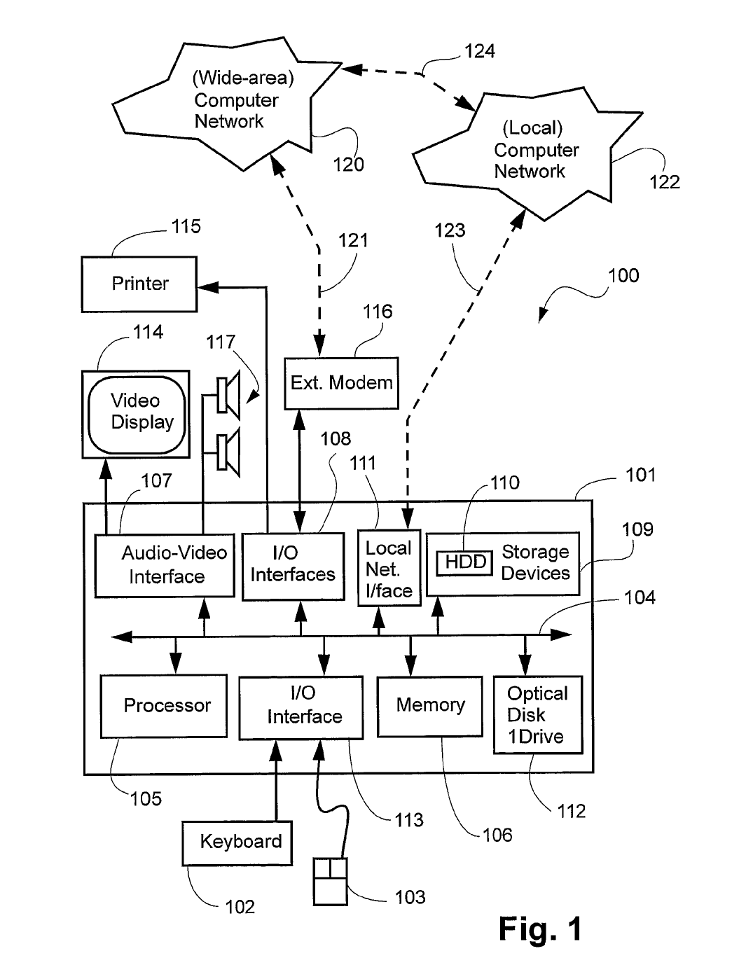

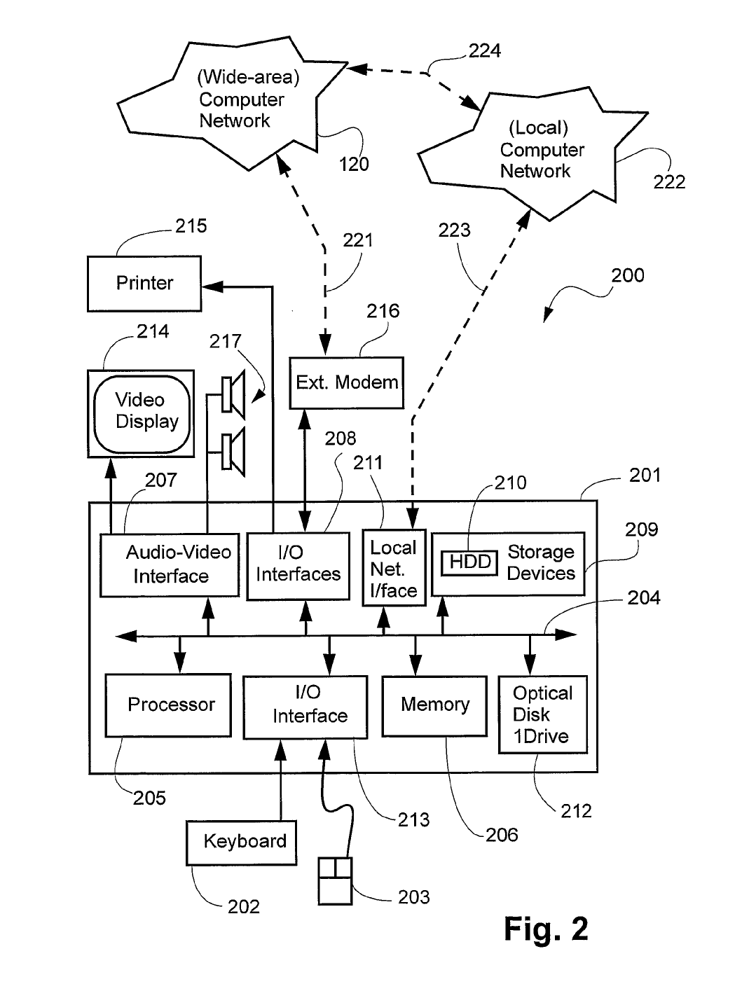

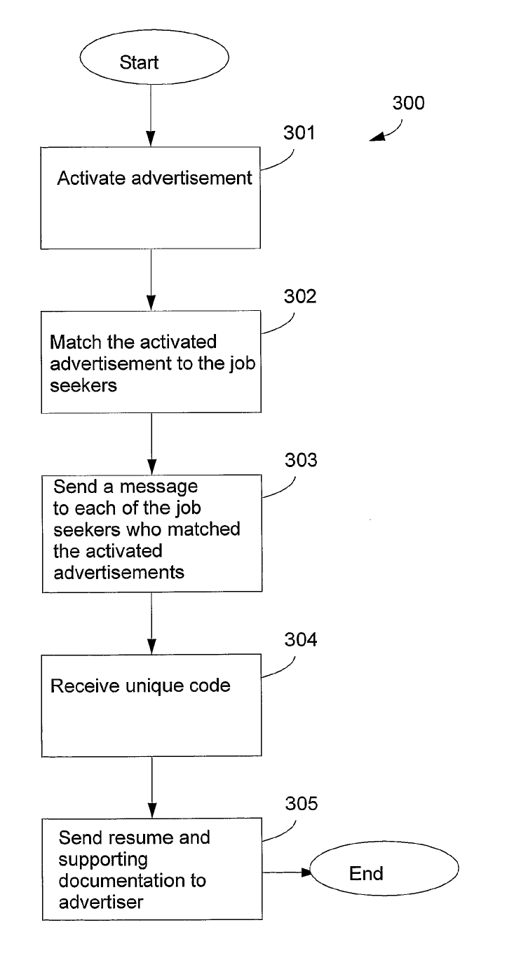

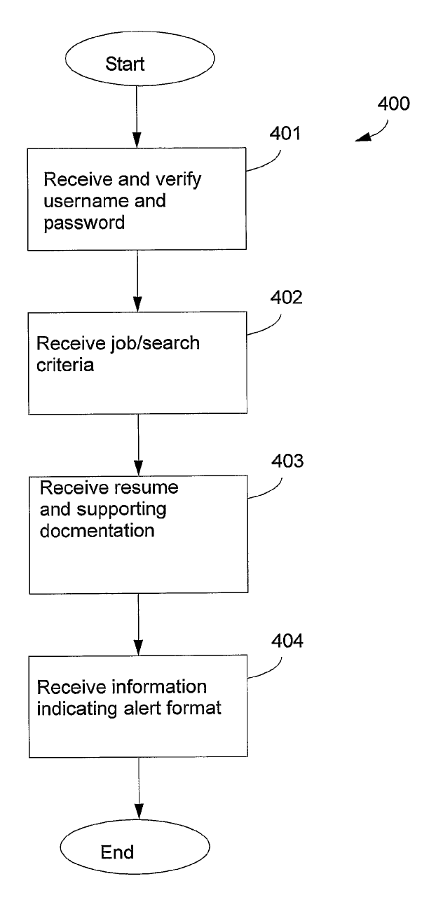

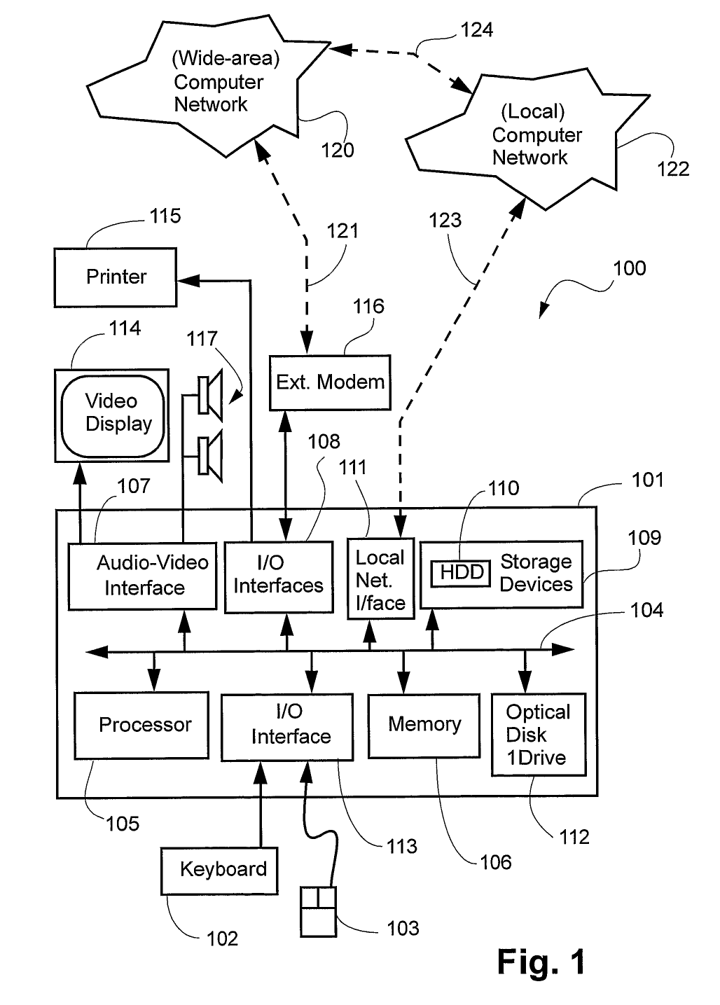

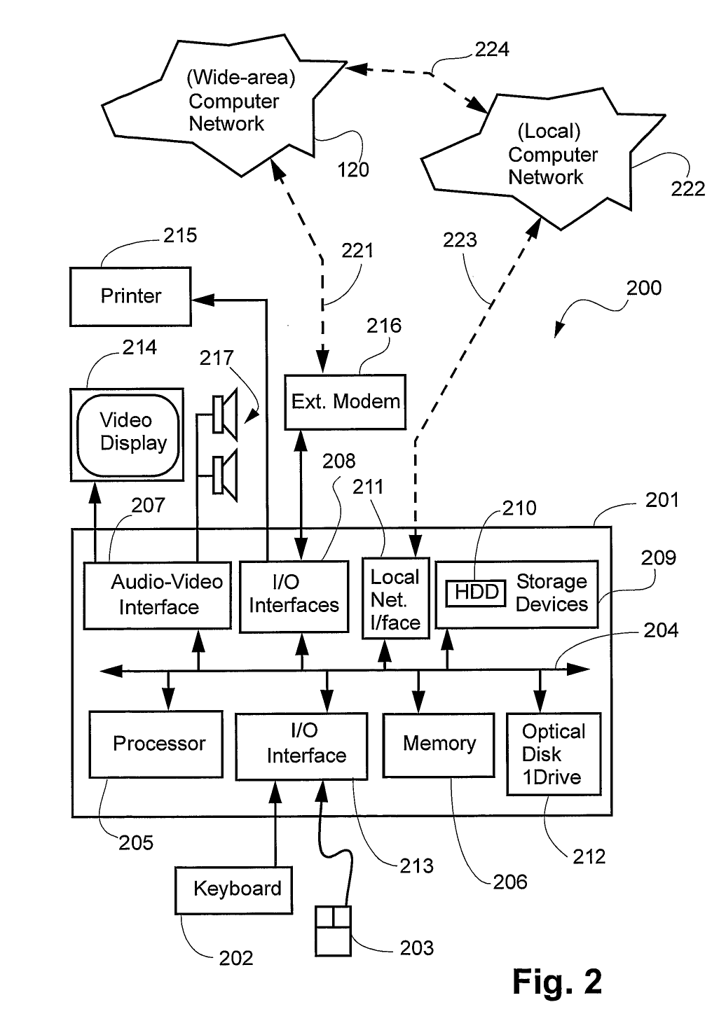

A recruitment method 300 (see FIG. 3) is described below with reference to FIGS. 1 to 4. A method 400 of searching for recruitment information is also described. The methods 300 and 400 may be computer-implemented methods practiced over a computer network 120 comprising computers 100 and 200 connected thereto, as shown in FIGS. 1 and 2. Preferably, the method 300 may be implemented as one or more software modules executing within the computers 100 and 200. In particular, the steps of the described methods may be affected by instructions in the software that are carried out by the computers 100 and 200. The instructions may form the one or more software modules with each of the modules performing one or more particular tasks. One or more of these software modules may generate and manage a user interface. In accordance with a preferred embodiment, this user interface may be in the form of a Website. This Website may comprise a plurality of pages. The Website may be also be configured as a portal referencing (or with links to) one or more further Websites.

The software implementing the described methods may be stored in a computer readable medium, including the storage devices described below, for example. The software may be loaded into one or more of the computers 100 and 200 from the computer readable medium, and then be executed by the computers 100 and 200. A computer readable medium having such software or computer program recorded on it is a computer program product. The use of the computer program product in the computers 100 and 200 preferably affects an advantageous apparatus for implementing the described methods.

As seen in FIG. 1, the computer 100 is formed by a computer module 101, input devices such as a keyboard 102 and a mouse pointer device 103, and output devices including a printer 115, a display device 114 and loudspeakers 117. An external Modulator-Demodulator (Modem) transceiver device 116 may be used by the computer module 101 for communicating to and from a communications network 120 via a connection 121. The network 120 may be a wide-area network (WAN), such as the Internet or a private WAN. The network 120 may also be implemented over a telecommunications network and may include one or more wireless connections or sections. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the network 120.

The computer module 101 typically includes at least one processor unit 105, and a memory unit 106 for example formed from semiconductor random access memory (RAM) and read only memory (ROM). The module 101 also includes a number of input/output (I/O) interfaces including an audio-video interface 107 that couples to the video display 114 and loudspeakers 117, an I/O interface 113 for the keyboard 102 and mouse 103 and optionally a joystick (not illustrated), and an interface 108 for the external modem 116 and printer 115. In some implementations, the modem 116 may be incorporated within the computer module 101, for example, within the interface 108. The computer module 101 also has a local network interface 111 which, via a connection 123, permits coupling of the computer system 100 to a local computer network 122, known as a Local Area Network (LAN). As also illustrated, the local network 122 may also couple to the wide network 120 via a connection 124, which would typically include a so-called “firewall” device or similar functionality. The interface 111 may be formed by an Ethernet™ circuit card, a wireless Bluetooth™ or an IEEE 802.11 wireless arrangement.

The interfaces 108 and 113 may afford both serial and parallel connectivity, the former typically being implemented according to the Universal Serial Bus (USB) standards and having corresponding USB connectors (not illustrated). Storage devices 109 are provided and typically include a hard disk drive (HDD) 110. Other devices such as a floppy disk drive and a magnetic tape drive (not illustrated) may also be used. An optical disk drive 112 is typically provided to act as a non-volatile source of data. Portable memory devices, such optical disks (eg: CD-ROM, DVD), USB-RAM, and floppy disks for example may then be used as appropriate sources of data to the system 100.

The components 105 to 113 of the computer module 101 typically communicate via an interconnected bus 104 and in a manner which results in a conventional mode of operation of the computer system 100 known to those in the relevant art. Examples of computers on which the described arrangements can be practised include IBM-PC's and compatibles, Sun Sparcstations, Apple Mac™ or alike computer systems evolved therefrom.

Typically, the application programs discussed above are resident on the hard disk drive 110 and are read and controlled in execution by the processor 105. Intermediate storage of such programs and any data fetched from the networks 120 and 122 may be accomplished using the semiconductor memory 106, possibly in concert with the hard disk drive 110. In some instances, the application programs may be supplied to the user encoded on one or more CD-ROM and read via the corresponding drive 112, or alternatively may be read by the user from the networks 120 or 122. Still further, the software can also be loaded into the computer system 100 from other computer readable media.

Computer readable media refers to any storage medium that participates in providing instructions and/or data to the computer system 100 for execution and/or processing. Examples of such media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 101. Examples of computer readable transmission media that may also participate in the provision of instructions and/or data include radio or infra-red transmission channels as well as a network connection to another computer or networked device, and the Internet or Intranets including e-mail transmissions and information recorded on the Website and the like.

The second part of the application programs and the corresponding code modules mentioned above may be executed to implement one or more graphical user interfaces (GUIs) to be rendered or otherwise represented upon the display 114. Through manipulation of the keyboard 102 and the mouse 103, a user of the computer system 100 and the application may manipulate the interface to provide controlling commands and/or input to the applications associated with the GUI(s).

The computer 200 has a similar configuration to the computer 100, as seen in FIG. 2.

There are three main categories of users of the described methods and the Website as follows:

(i) administrator;

(ii) advertisers; and

(iii) job seeker.

The administrator is responsible for maintaining all aspects of the Website and uses one or more of the described methods for performing administration tasks (e.g., billing) in relation to the Website. The administrator has access to all pages of the Website. The administrator may access various features available to manage business tasks.

The advertisers may be any individual, company, business entity, and/or other entity, seeking to recruit an individual, temporary worker and/or contractor. A particular advertiser may be seeking to recruit on behalf of itself or on behalf of another. For example, the advertiser may be a recruiter (or head-hunter), an employment/career consultant and/or an employment agency.

As described herein, an advertiser may register with the Website to perform the described methods using the computer 200, for example. In this instance, the advertiser may be added to a database (‘the Website database’) stored on the hard disk drive 110 of the computer 100.

The job seekers are those individuals, temporary workers and/or independent contractors who have registered with the Website seeking access to advertisements using the Website.

Each of the users (i.e., administrator, advertisers and job seekers) has a username (e.g., email address, or nominated username) and a password, which the user may view and update at any point in time. The username and password are required to login to the Website and access any restricted pages of the Website.

To register with the Website, the job seeker completes an online registration form providing their name, email address, mobile telephone number, and landline telephone number. The job seeker is then added to the Website database stored on the hard disk drive 110 of the computer 100. Alternatively, details of the job seekers may be stored on an external database or computer readable medium connected to the network 120. Once the job seeker is registered, the Website may be automatically configured to forward an email to the job seeker confirming the job seeker's account.

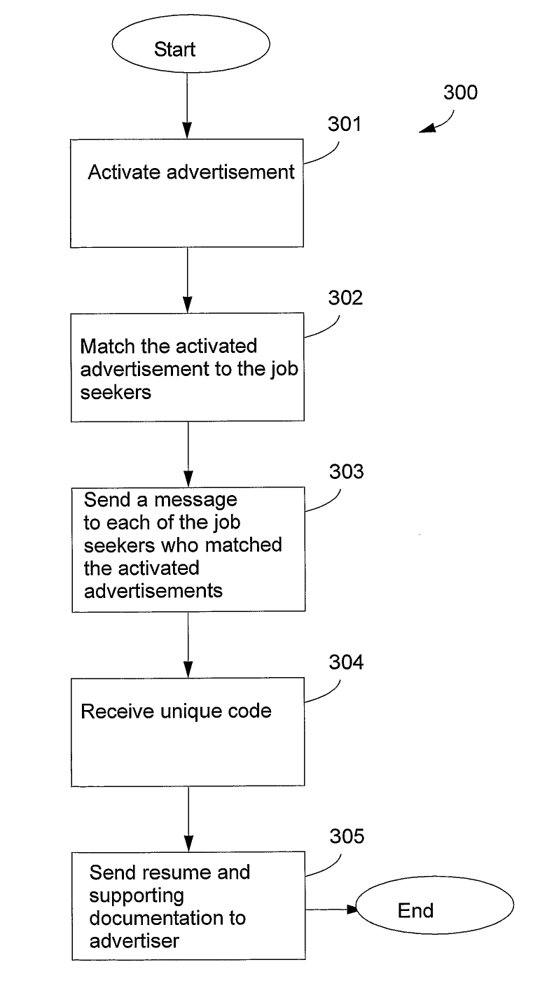

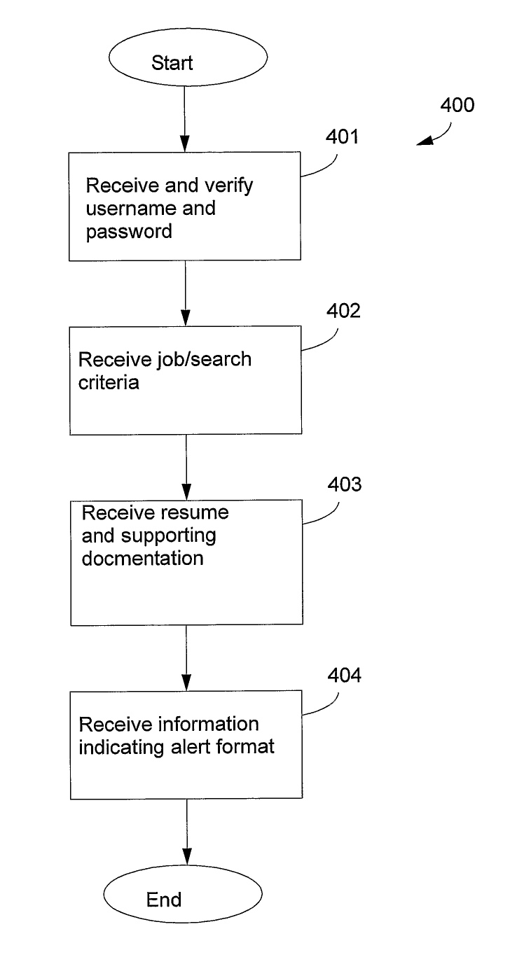

A method 400 of searching for recruitment information will now be described with reference to FIG. 4. The recruitment information may comprise a job description including the name of an entity advertising the job, location information (e.g., Australia, Sydney), job category information (e.g., retail buying, PR marketing, retail creative, retail stores, casuals, part-time, management, manufacturing, media, magazines, finance, and administration), a specific job function (e.g., marketing manager, stylist, dresser, PR manager, PR assistant, brand manager), job criteria (e.g., qualifications, salary, other compensation) and/or other relevant information. The recruitment information may also comprise a project or assignment description.

The method 400 and the method 300 will be described by way of example with reference to one particular advertiser and one particular job seeker.

The method 400 may be implemented as software resident on the hard disk drive 110 and being controlled in its execution by the processor 105.

The method 400 begins at step 401, where the Website receives a username and password corresponding to the particular job seeker. For example, the job seeker may enter their username and password into a hyper-text mark-up language (HTML) page of the Website displayed on the display 214 of the computer 200. The username and password is then uploaded by the processor 205 to the computer 100 where the username and password are verified by the processor 105 using the Website database.

At the next step 402, the Website receives job criteria (or search criteria) for a job for which the job seeker is searching. For example, the job seeker may enter location information (e.g., Asia, Australia, Canada, Europe, Ireland, New Zealand, Shanghai, Hong Kong, Singapore), a job category (e.g., retail buying, PR marketing, retail creative, retail stores, casuals, part-time, management, manufacturing, media, magazines, finance, and administration) and then a specific job function (e.g., marketing manager, stylist, dresser, PR manager, PR assistant, brand manager, electrician, carpenter, accountant, accounts clerk, lawyer) into a HTML page of the Website displayed on the display 214 of the computer 200. The location, category and function information may be selected by the job seeker from drop down menus displayed by the Website page. The location, category and function information is then uploaded by the processor 205 to the computer 100 where the information is stored in the Website database against the Job seeker's username. The job criteria may comprise any combination of location, category, and function).

The method 400 continues at the next step 403, where the Website receives a resume and supporting documentation corresponding to the job seeker. The resume comprises information about the job seeker. The job seeker may provide an electronic version (e.g., portable document format (PDF), Word™ etc) of their resume together with certified copies of certificates, via a HTML page of the Website displayed on the display 214 of the computer 200. The resume and supporting documentation are then uploaded by the processor 205 to the computer 100 where the resume and supporting documentation are stored on the Website database against the job seeker's username. Again, the resume and supporting documentation may be stored in an remote database within a computer readable medium. The resume and supporting documentation stored with the Website database are preferably only able to be accessed by the administrator and the particular job seeker (e.g., via a password).

The method 400 continues at the next step 404, where the Website receives information indicating whether the job seeker wishes to receive job alerts. The Website preferably also receives information indicating in what form the job seeker wishes to receive the job alerts. For example, the job seeker may receive the job alerts in the form of a short message service (SMS) message or an email message. Alternatively, the job alerts may be configured in accordance with some other communications protocol such as mobile instant messaging (MIM), Internet faxing, the multimedia messaging service (MMS), unified messaging (UM), J-Phone™'s “SkyMail”, NTT Docomo™'s “Short Mail”, NTT Docomo™'s “i-mode”, RIM™'s BlackBerry™, Nokia™'s “smart messaging”, Java™ message service (JMS) or the like. The job seeker may make this selection from a drop down menu within a page of the Website. Again, this information is stored in the Website database (or on some other database) against the Job seeker's username.

The advertiser provides an electronic version (e.g., portable document format (PDF), Word™ etc) of a job advertisement to the Website. The advertisement may be provided via a HTML page of the Website displayed on a display (e.g., the display 214) of a computer connected to the network 120 (e.g., the computer 200). Once uploaded the advertisement is stored in the Website database together with the advertiser's details. The advertiser is charged a fee by the administrator for placing the advertisement. This fee may be billed in the form of a fee charged to the advertiser's telephone account, for example.

The advertiser also classifies the uploaded advertisement by providing location, category and function information to be associated with the advertisement. The location, category and function information may be selected by the advertiser from drop down menus within the page of the Website and then be uploaded to the Website. For example, the advertiser may select a location (e.g., Asia), a city (e.g., Shanghai), a job category (e.g., retail buying, PR marketing, retail creative, retail stores, casuals, part-time, management, manufacturing, media, magazines, finance, and administration) and a job function (e.g., (e.g., marketing manager, stylist, dresser, PR manager, PR assistant, brand manager), for the uploaded job advertisement. The uploaded location, category and function information is stored in the Website database together with the uploaded advertisement and the advertiser's details. For example, the uploaded location, category and function information may be stored as metadata associated with the advertisement. Again, the advertisement and associated information (or metadata) may be stored on a remote database configured within a computer readable medium.

The recruitment method 300 will now be described with reference to FIG. 3. The method 300 may be implemented as software resident on the hard disk drive 110 and being controlled in its execution by the processor 105. The method 300 will be described by way of example with reference to on particular advertiser.

The method 300 begins at step 301 where the processor 105 activates the advertisement. The processor 105 activates the advertisement upon input from the advertiser using the Website. For example, the advertiser may activate the advertisement which they have previously stored within the Website database, by checking a check box on a page of the Website.

At the next step 302, upon the advertisement being activated, the processor 105 searches the Website database and matches the classifications of the activated advertisement to one or more of the job seekers. In particular, at step 302, the processor 105 performs the step of comparing the location, category and function information associated with the activated advertisement to the location, category and function information associated with each of the job seekers in the Website database. In the present example, the classification information of the activated advertisement is matched to the job seeker.

Then at the next step 303, based on the comparison, the processor 105 sends a message to the job seeker who matched the activated advertisement and any other job seekers who matched the activated advertisement. The message is preferably a short text message (e.g., approximately sixty (60) text characters) in the form of an SMS message sent to each of the matched job seeker's mobile telephone, palmtop computer, personal digital assistant, pager or other form of personal communication device. The text message preferably comprises enough infromation to allow the job seeker to know whether or not they wish to apply for the job. For example, the text message may comprise one or more of the location of the job, the name of the advertiser that posted the advertisement and the job title. The text message also comprises a unique code for the job seeker. The unique code is used to identify the job seeker as described below. The message may be sent at step 303 via a transmitter (e.g., a wireless transmitter/modem or a hardwired modem) connected to the computer module 101.

Alternatively, the message sent at step 303 may be in the form of an email message sent to one or more of the matched job seeker's personal computer (e.g., the computer 200), palmtop computer, personal digital assistant or other personal communication device, depending on whether each of the job seekers selected to receive email alerts, SMS alerts or alerts according to some other suitable communications protocol, at step 404. In a further alternative the message sent at step 303 may comprise one or more multimedia objects such as audio, video, rich text and even images (e.g., for a visual message), sent to one or more of the matched job seeker's mobile telephone, palmtop computer, personal digital assistant or other form of personal communication device. The message may be in the form of a communications protocol such as mobile instant messaging (MIM), Internet faxing, the multimedia messaging service (MMS), unified messaging (UM), J-Phone™'s “SkyMail”, NTT Docomo™'s “Short Mail”, NTT Docomo™'s i-mode™ RIM™'s BlackBerry™, Nokia™'s “smart messaging”, Java™ message service (JMS) or the like.

As well as a message being sent to a job seeker's mobile telephone, palmtop computer, pager, personal digital assistant or the like, at step 303, a message in the form of a predetermined audio, video, image or text message may also be sent to a “land-line” telephone nominated by the job seeker.

Each of the job seekers who received a message at step 303 are automatically charged a predetermined amount by the administrator. In one example, this charge may be in the form of a higher rate (i.e., a premium rate) than normally charged for sending an SMS message or the like, which is billed to the job seeker's mobile telephone account.

The method 300 continues at the next step 304, where the processor 105 receives a unique code from one of more of the job seekers to whom a message was sent at step 303. In the present example, the processor 105 receives a unique code from a particular one of job seekers who wishes to apply for the job advertised in the activated advertisement. The unique code is preferably received in a reply SMS message sent by the job seeker from the job seeker's mobile telephone. Again, the job seeker who sent the message is charged a predetermined amount by the administrator, which may be in the form of a higher rate (i.e., premium rate) than normally charged for sending an SMS. The message may be received at step 304 via a receiver (e.g., a wireless transmitter/modem or a hardwired modem) connected to the computer module 101.

Alternatively, the unique code may be sent to the Website, at step 304, in the form of an email or Internet fax, for example, transmitted from the job seeker's personal computer (e.g., the computer 200), palmtop computer, personal digital assistant, or personal communication device. The unique code may be sent in accordance with any other suitable communications protocol such as those described above.

At the next step 305, upon receiving the unique code, the processor 105 sends the previously stored resume and supporting documentation for the job seeker corresponding to the received unique code to the advertiser. The resume and supporting documentation may be sent to the advertiser electronically in the form of an email attachment, an SMS or in accordance with some other communications protocol such as those described above. The processor 105 may also send a confirmation message to the job seeker. Accordingly, the jobseekers receive alerts for jobs that the jobseeker wants and they may apply by way of an SMS message or the like.

The step 302 of comparing information associated with an activated advertisement to the information associated with a particular job seeker is performed for each newly activated advertisement.

The step of comparing information associated with each newly activated advertisement to the information associated with a particular job seeker, at step 302, is continually performed for that job seeker, until that job seeker “opts-out” (i.e., indicates that they do not wish to continue to receive job alerts). Accordingly, the jobseeker will continually receive job alerts without the need of periodically logging-on to the Website, entering search criteria and browsing advertisements that have been placed by advertisers. The job seeker may opt-out by logging-on to the Website and indicating that they do not wish to continue to receive job alerts, for example, by selecting a check-box on the Website.

For the employer, when their job advertisement fits the profile and qualifications of a job seeker, they will receive notification and an application within a very short amount of time. Suitable job seekers may be reached almost instantly.

### INDUSTRIAL APPLICABILITY

It is apparent from the above that the arrangements described are applicable to the computer and data processing industries.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of'. Variations of the word “comprising”, such as “comprise” and “comprises” have correspondingly varied meanings.

What is claimed is:

1-54. (canceled)

55. A computer-implemented recruitment method, said method comprising the steps of:
storing information about an individual in a computer readable memory together with one or more lob search criteria provided by the individual;
storing one or more advertisements for one or more lobs, in a computer readable medium together with classification information associated with each of the advertisements, the advertisements being provided by one or more advertisers;
comparing the job search criteria provided by the individuals with the classification information associated with an advertisement for a job each time an advertisement is placed by an advertiser and matching the job search criteria with the classification information associated with at least one of the advertisements;
where the classification information associated with the at least one advertisement matches the job search criteria associated with the individual, sending a message describing the job associated with the at least one advertisement to one or more communications devices nominated by the individual; and
upon receiving a reply to the message from the individual, sending the stored information about the individual, via a communications network, to an advertiser associated with the advertisement.

56. An apparatus for use in recruitment, said apparatus comprising:
a computer readable medium for storing information about one or more individuals together with one or more lob search criteria provided by the individuals and one or more advertisements provided by one or more advertisers for one or more lobs together with classification information associated with each of the advertisements;
a processor for comparing the lob search criteria provided by the individuals with the classification information associated with an advertisement for a lob each time an advertisement is placed by an advertiser and matching the job search criteria with the classification information associated with at least one of the advertisements;
wherein the processor is configured to send a message describing the job associated with the at least one advertisement to one or more communications devices nominated by the individual where the processor identifies that the classification information associated with the at least one advertisement matches the lob search criteria associated with the individual; and
upon receiving a reply to the message from the individual, the processor sends the stored information about the individual, via a communications network, to an advertiser associated with the advertisement.

57. An apparatus for use in recruitment according to claim 56 wherein the processor further includes a transmitter for sending the message describing the job associated with the at least one advertisement to the communications device nominated by the individual and a receiver for receiving the reply to the message from the individual.

58. A computer program product including a computer readable medium having recorded thereon a computer program for implementing a recruitment method, said program comprising:
code for storing information about an individual in a computer readable memory together with one or more lob search criteria provided by the individual;
code for storing one or more advertisements for one or more lobs, in a computer readable medium together with classification information associated with each of the advertisements, the advertisements being provided by one or more advertisers;
code for comparing the job search criteria provided by the individuals with the classification information associated with an advertisement for a job each time an advertisement is placed by an advertiser and matching the job search criteria with the classification information associated with at least one of the advertisements;
where the classification information associated with the at least one advertisement matches the job search criteria associated with the individual, code for sending a message describing the job associated with the at least one advertisement to one or more communications devices nominated by the individual; and
upon receiving a reply to the message from the individual, code for sending the stored information about the individual, via a communications network, to an advertiser associated with the advertisement.

59. A computer-implemented recruitment method according to claim 55, wherein the communication device is selected from the group consisting of “a telephone, a mobile telephone, a personal digital assistant, a pager or a personal computer”.

60. A computer-implemented recruitment method according to claim 55, wherein the stored information about the individual is sent to the advertiser via one or more of “an email or an SMS message”.

61. A computer-implemented recruitment method according to claim 55, wherein the message is sent over one or more of “a wireless communication network, a telecommunications network or the Internet”.

62. A computer-implemented recruitment method according to claim 55, wherein the message is one or more of “an SMS message, an Email message, an audio message, a video message or comprises one or more images”.

63. An apparatus for use in recruitment according to claim 56, wherein the communication device is selected from the group consisting of “a telephone, a mobile telephone, a personal digital assistant, a pager or a personal computer”.

64. An apparatus for use in recruitment according to claim 56, wherein the stored information about the individual is sent to the advertiser via one or more of “an email or an SMS message”.

65. An apparatus for use in recruitment according to claim 56, wherein the message is sent over one or more of “a wireless communication network, a telecommunications network or the Internet”.

66. An apparatus for use in recruitment according to claim 56, wherein the message is one or more of “an SMS message, an Email message, an audio message, a video message or comprises one or more images”.

67. A computer program product including a computer readable medium having recorded thereon a computer program for implementing a recruitment method according to claim 58, wherein the communication device is selected from the group consisting of “a telephone, a mobile telephone, a personal digital assistant, a pager or a personal computer”.

68. A computer program product including a computer readable medium having recorded thereon a computer program for implementing a recruitment method according to claim 58, wherein the stored information about the individual is sent to the advertiser via one or more of “an email or an SMS message”.

69. A computer program product including a computer readable medium having recorded thereon a computer program for implementing a recruitment method according to claim 58, wherein the message is sent over one or more of “a wireless communication network, a telecommunications network or the Internet”.

70. A computer program product including a computer readable medium having recorded thereon a computer program for implementing a recruitment method according to claim 58, wherein the message is one or more of “an SMS message, an Email message, an audio message, a video message or comprises one or more images”.
